(19) United States
(12) Patent Application Publication
(10) Pub. No.: US 2007/0257138 A1
(43) Pub. Date: Nov. 8, 2007

(54) Spray nozzle kit

(76) Inventor: Horst Riese, Sanford, FL (US)

Correspondence Address: Stephen R. Greiner, Esquire;GREINER LAW OFFICES, P.C., Suite 110, 6701 Democracy Blvd., Bethesda, MD, 20817, US

(21) Appl. No.: 11/415,292

(22) Filed: May 2, 2006

(51) Int. Cl. B05B 1/30; B05B 15/08; A62C 31/02

(52) U.S. Cl. 239/589; 239/587.4; 239/580

(57) ABSTRACT

A spray nozzle kit including a nozzle and a wrench. The nozzle includes a tubular body having an inlet for attachment to one end of a pipe and an outlet positioned opposite the inlet. A ball is provided for positioning within the tubular body. The ball has a passageway therein for the movement of a pressurized fluid ejected from the pipe into the inlet. A cover plate is provided for threadable fastening to the outlet to retain the ball within the tubular body. The cover plate has an opening for the passage of pressurized fluid from the passageway in the ball. The cover plate also has a pair of recesses located on opposite sides of the opening. A cap is removably positioned within the outlet for preventing dirt from entering the tubular body prior to the positioning of the ball within the tubular body and prior to the threadable fastening of the cover plate to the outlet. A wrench is used for rotating the cover plate. The wrench has a pair of pins that can be positioned within the recesses in the cover plate for applying torque to the cover plate.

### FIELD OF THE INVENTION

The present invention relates generally to water-jet means for swimming pools.

### BACKGROUND OF THE INVENTION

The installation of spray nozzles in swimming pools has never been easy. Many makes and models of nozzles are threaded onto pipes requiring that wrenches often be engaged with them in hard-to-reach locations. Furthermore, if care is not taken, pool construction debris can foul a nozzle thereby necessitating its repair or replacement even prior to use. A need, therefore, exists for a spray nozzle that is easily installed in a variety of settings that is virtually impervious to fouling.

### SUMMARY OF THE INVENTION

In light of the problems associated with the known spray nozzles used in circulating water in swimming pools, it is a principal object of the invention to provide a kit that makes installing a spray nozzle a simple matter and that excludes concrete, dirt, and construction debris from the interior of the nozzle that can block flow through the nozzle.

It is another object of the invention to provide a nozzle as part of a kit as described above that will direct water in a direction determined by a user. Thus, water can be jetted up, down, left or right as a user may desire.

It is a further object of the invention to provide a nozzle of the type described that is wholly made of durable plastic and does not require connection to ground.

It is an object of the invention to provide improved features and arrangements thereof in a spray nozzle kit for the purposes described that is lightweight in construction, inexpensive to manufacture, and fully dependable in use.

Briefly, the kit in accordance with this invention achieves the intended objects by featuring a spray nozzle with a tapered body. The tapered body has a tubular conduit of intermediate diameter. A tubular inlet is affixed to the back of the tubular conduit and is of small diameter. A tubular outlet is affixed to the front of the tubular conduit and is of large diameter. A funnel is affixed to, and extends rearwardly from, the tubular conduit into the tubular inlet. The funnel defines an orifice for channeling flow through the tapered body. The funnel also defines an annulus between itself and the tubular inlet for inserting and securing a water-delivery pipe. A ball is positioned within the tubular conduit and the tubular outlet, the ball has a passageway therein for the movement of a pressurized fluid passing through the orifice. A cover plate is threadably fastened to the outlet for retaining the ball within the tubular conduit and the tubular outlet. The cover plate has an opening therein for the passage of pressurized fluid from the passageway in the ball. The cover plate also has a pair of recesses located on opposite sides of the opening for engagement by a wrench adapted to rotate the cover plate.

The foregoing and other objects, features, and advantages of the spray nozzle kit will become readily apparent upon further review of the following detailed description of the preferred embodiment as illustrated in the accompanying drawings.

### BRIEF DESCRIPTION OF THE DRAWINGS

The spray nozzle kit can be more readily described with reference to the accompanying drawings, in which:

FIG. 1 is a side elevational view of a spray nozzle, with portions broken away to reveal details thereof, forming part of the kit in accordance with the present invention.

FIG. 2 is a longitudinal, cross-sectional view of the body of the spray nozzle of FIG. 1 with a disposable debris excluding cap in place.

FIG. 3 is an exploded perspective view of the spray nozzle and spanner for use in assembling the spray nozzle.

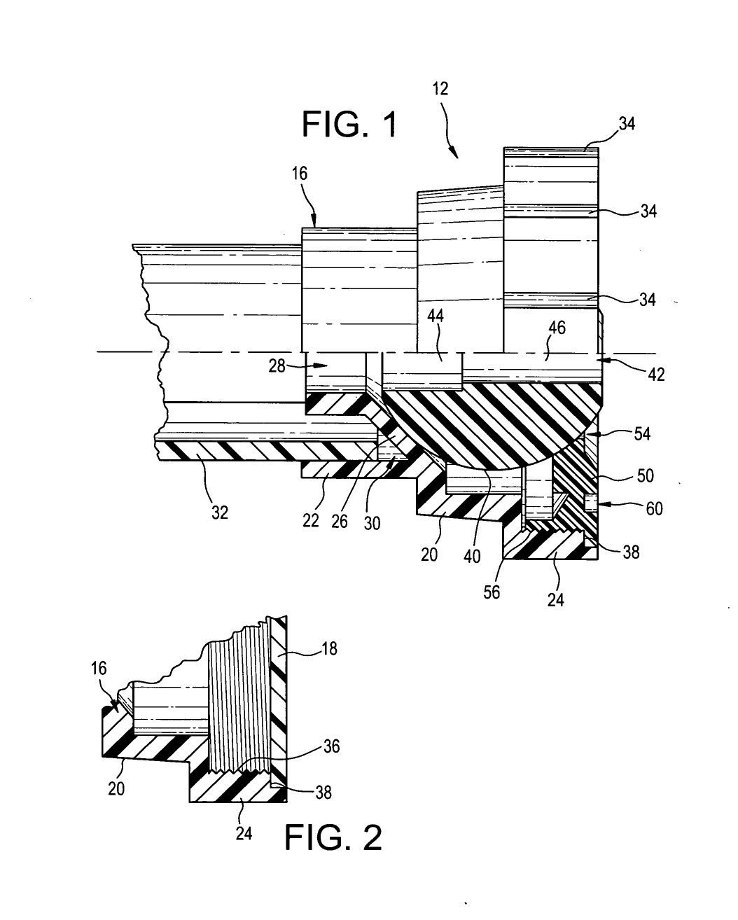

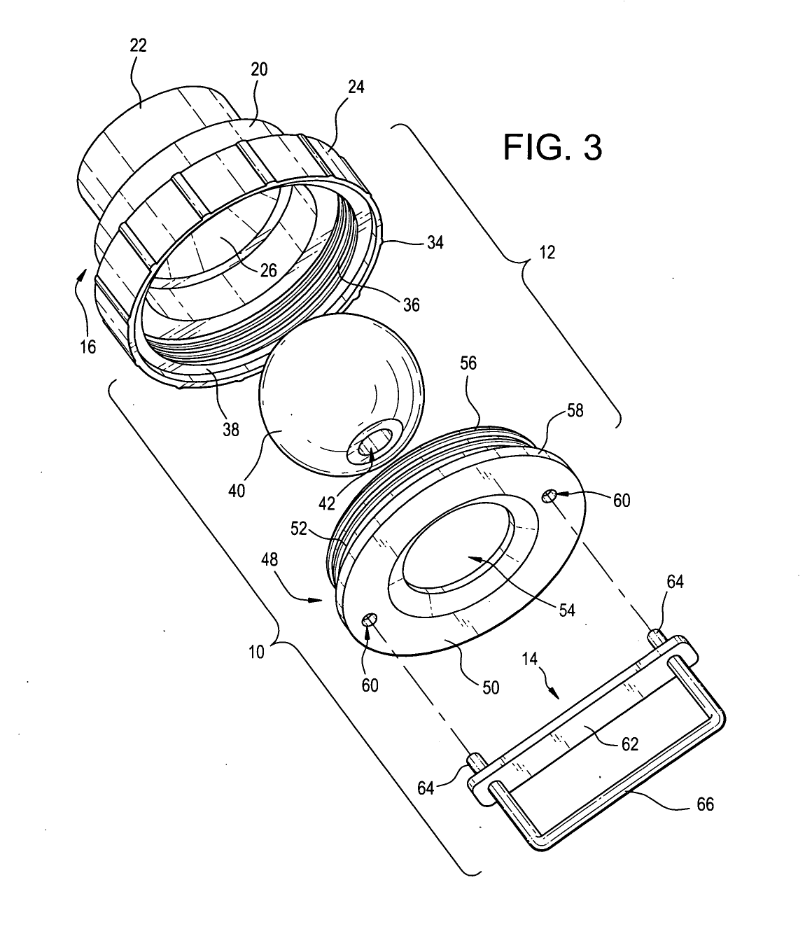

Similar reference characters denote corresponding features consistently throughout the accompanying drawings.

### DETAILED DESCRIPTION OF THE PREFERRED EMBODIMENT

Referring now to the FIGS., a spray nozzle kit in accordance with the present invention is shown at 10. Kit 10 includes a three-part nozzle 12 and a wrench 14 for assembling nozzle 12. Prior to assembly of nozzle 12, its tapered body 16 is capped by a removable cap 18 to prevent the entry of settable materials normally used to form the side walls of a swimming pool wherein nozzle 12 is employed.

Nozzle 12 has a tapered body 16 with tubular conduit 20 of intermediate diameter. Affixed to the back of conduit 20 is a tubular inlet 22 of small diameter. Affixed, however, to the front of conduit 20 is a tubular outlet 24 of large diameter. Affixed to, and extending rearwardly from, the periphery of conduit 20 into inlet 22 is a funnel 26 with an orifice 28 for channeling flow through body 16. Into the annulus 30 formed between the inside of inlet 22 and the outside of funnel 26, the end of a water-delivery pipe 32 can be secured by adhesive or other means.

Tubular outlet 24 is specially configured. In this regard, outlet 24 is provided with a number of elevated ribs 34 about its exterior for stabilizing nozzle 12 in the wall of a swimming pool. The interior of outlet 24 is provided with helical threads as shown at 36. Adjacent threads 36, at its front, outlet 24 is provided with a peripheral groove 38 for receiving and holding cap 18 which is a resilient disk lacking any openings and whose outer edge is held snugly by friction within groove 38.

Positioned within tapered body 16, and seated against the inside of funnel 26, is a ball 40. Ball 40 has a diameter that is approximately equal to that of tubular inlet 22 and has a passageway 42 extending from the front to the back thereof. Passageway 42 tapers from a back end 44 wherein it has substantially the same diameter as that of orifice 28 to a front end 46 wherein it is somewhat smaller. The degree of taper from back end 44 to front end 46 is largely a matter of design choice dependent on the flow rates and water velocities desired from nozzle 12 as well as pressure gradients through passageway 42.

Cover plate 48 includes a disk 50 having helical threads 52 about its periphery that are adapted to be screwed into threads 36 around the interior of tubular outlet 24. Disk 50 also has a circular opening 54 at its center, that is smaller in diameter than ball 40 and is sized to retain ball 40 snugly against funnel 26 when disk 50 it screwed into body 16. To prevent leaks at the junction of ball 40 and disk 50, opening 54 is contoured so that disk 50 fits flush against ball 40. Affixed to, and extending rearwardly from, the periphery of disk 50 is a ring 56 of the same diameter that is externally threaded so as to double the length of helical threads 52 to match that of threads 36 thereby increasing the strength of the connection between body 16 and cover plate 48 while minimizing the weight of nozzle 12. Affixed to, and extending outwardly from, the front of disk 50 is a peripheral flange 58 adapted to be seated within peripheral groove 38 that serves as a stop to prevent the over-insertion of cover plate 48 into body 16.

Cover plate 48 is provided with a pair of cylindrical recesses 60 respectively positioned on opposite sides of opening 54. Recesses 60 partially penetrate the front of disk 50 midway between opening 54 and peripheral flange 58.

Kit 10 includes wrench 14 for threading cover plate 48 into body 16. Wrench 14 has an elongated base plate 62 for positioning against the front of disk 50 and a pair of pins 64, adapted for snug positioning within recesses 60, that extend rearwardly from the back of base plate 62. A loop-type handle 66 is affixed to the front of base plate 62 for applying torque to pins 64 when such are engaged with cover plate 48 for screwing cover plate 48 into tapered body 16.

The use of spray nozzle kit 10 is straightforward. First, assuming the pipe 32 is in place in a swimming pool under construction and cap 18 is fitted within groove 38, tapered body 16 is joined to pipe 32 by applying a suitable adhesive within annulus 30 and slipping tubular inlet 22 over the end of pipe 32. After the adhesive has cured and the swimming pool is ready to be filled, cap 18 is removed from body 16 by lightly prying it from groove 38. Next, ball 40 is inserted, at an orientation that will discharges water either up, down, right, or left, into body 16 which is clear of debris as a result of cap 18 being kept in place while concrete is poured and cover plate 48 is screwed into tubular outlet 24 to hold ball 40 against funnel 26. Rotating cover plate 48 is, of course, accomplished by inserting pins 64 of wrench 14 into recesses 60 in cover plate 48 and providing a light torque to wrench handle 66. The entire process of assembling nozzle 12, excluding time spent on waiting for adhesives to cure, requires just a few minutes of time, minimal expertise, and little training. The use of kit 10, therefore, reduces pool construction costs for both the builder and the buyer.

While spray nozzle kit 10 has been described with a high degree of particularity, it will be appreciated by those skilled in the art that modifications can be made to it. Therefore, it is to be understood that utility patent protection should not extend merely to kit 10, but should encompass any and all spray nozzle and kit embodiments within the scope of the following claims.

I claim:

1. A spray nozzle kit, comprising:
a nozzle including:
a tubular body having an inlet for attachment to one end of a pipe and having an outlet positioned opposite said inlet;
a ball being adapted for positioning within said tubular body, said ball having a passageway therein for the movement of a pressurized fluid ejected from the pipe into said inlet;
a cover plate being adapted for threadable fastening to said outlet for retaining said ball within said tubular body, said cover plate having an opening therein for the passage of pressurized fluid from the passageway in said ball, said cover plate also having a pair of recesses located on opposite sides of said opening; and,
a cap being removably positioned within said outlet for preventing dirt from entering said tubular body prior to the positioning of said ball within said tubular body and prior to the threadable fastening of said cover plate to said outlet; and,
a wrench for rotating said cover plate, said wrench including:
a base plate having opposed sides;
a pair of pins being affixed to, and projecting from, one of said opposed sides of said base plate, said pins being adapted for positioning within said recesses in said cover plate; and,
a handle being affixed to, and extending from, the other one of said opposed sides of said base plate.

2. A spray nozzle, comprising:
a tapered body including:
a tubular conduit being of intermediate diameter;
a tubular inlet being affixed to the back of said tubular conduit and being of small diameter;
a tubular outlet being affixed to the front of said tubular conduit and being of large diameter; and,
a funnel being affixed to, and extending rearwardly from, said tubular conduit into said tubular inlet, said funnel defining an orifice for channeling flow through said tapered body, said funnel also defining an annulus between itself and said tubular inlet for inserting and securing a water-delivery pipe;
a ball being positioned within said tubular conduit and said tubular outlet, said ball having a passageway therein for the movement of a pressurized fluid passing through said orifice; and,
a cover plate threadably fastened to said outlet for retaining said ball within said tubular conduit and said tubular outlet, said cover plate having an opening therein for the passage of pressurized fluid from the passageway in said ball, said cover plate also having a pair of recesses located on opposite sides of said opening for engagement by a wrench adapted to rotate said cover plate.

3. A method for installing a spray nozzle, said method including the steps of:
providing a nozzle including:
a tubular body having an inlet for attachment to one end of a pipe and having an outlet positioned opposite said inlet;
a ball being adapted for positioning within said tubular body, said ball having a passageway therein for the movement of a pressurized fluid ejected from the pipe into said inlet;
a cover plate being adapted for threadable fastening to said outlet for retaining said ball within said tubular body, said cover plate having an opening therein for the passage of pressurized fluid from the passageway in said ball, said cover plate also having a pair of recesses located on opposite sides of said ball; and,
a cap being removably positioned within said inlet for preventing dirt from entering said tubular body prior to the positioning of said ball within said tubular body and prior to the threadable fastening of said cover plate to said outlet; and,
providing a wrench for rotating said cover plate, said wrench including:
a base plate having opposed sides;
a pair of pins being affixed to, and projecting from, one of said opposed sides of said base plate, said pins being adapted for positioning within said recesses in said cover plate; and,
a handle being affixed to, and extending from, the other one of said opposed sides of said base plate;
adhesively fastening said tubular body, with said cap being removably positioned within said outlet, to one end of a pipe;
removing said cap from said outlet;
positioning said ball within said tubular body;
inserting said cover plate into said outlet;
inserting said pins of said wrench into said recesses in said cover plate;
applying torque to said handle of said wrench so as to screw said cover plate into said outlet; and,
removing said pins of said wrench from said recesses.
